(19) United States
(12) Patent Application Publication
(10) Pub. No.: US 2025/0273758 A1
(43) Pub. Date: Aug. 28, 2025

(54) METHOD FOR DECOMPOSING LITHIUM COMPOUND

(71) Applicant: National Taiwan University of Science and Technology, TAIPEI CITY (TW)

(72) Inventor: Fu-Ming WANG, New Taipei City (TW)

(21) Appl. No.: 18/976,383

(22) Filed: Dec. 11, 2024

(30) Foreign Application Priority Data
Feb. 27, 2024 (TW) 113106896

(51) Int. Cl. H01M 10/54

(52) U.S. Cl. CPC H01M 10/54

(57) ABSTRACT

A method for decomposing a lithium compound includes decomposing the lithium compound by an organic compound. The organic compound is formed by reacting a nucleophilic compound and a compound containing at least one ethylene unsaturated group. The nucleophilic compound includes a barbiturate compound, thiobarbituric acid, cyanuric acid, trithiocyanic acid, or a pyrimidine compound. The compound containing at least one ethylene unsaturated group includes an acrylic epoxy resin, a maleimide compound, or a pyrimidine compound. The lithium compound includes lithium carbonate, lithium hydroxide, or a combination thereof.

### CROSS-REFERENCE TO RELATED APPLICATION

This application claims priority to Taiwan Application Serial Number 113106896, filed Feb. 27, 2024, which is herein incorporated by reference in its entirety.

### BACKGROUND

### Field of Invention

The present disclosure relates to a method for decomposing a lithium compound.

### Description of Related Art

A lithium compound such as lithium carbonate or lithium hydroxide is often used in the preparation of lithium-containing materials such as batteries, glass, ceramics, enamels, and so on. During the preparation process, the lithium compound may need to be decomposed. However, the lithium compound such as lithium carbonate or lithium hydroxide has high stability and is therefore not easily decomposed. Generally speaking, a high temperature of 700° C. to 900° C., a voltage above 4.5 V, or a strong acid is required to decompose lithium carbonate or lithium hydroxide. However, these harsh conditions make it difficult for the above decomposition methods to be widely used. Thus, there is an urgent need to develop other methods for decomposing the lithium compounds.

### SUMMARY

The present disclosure provides a method for decomposing a lithium compound, and the method includes decomposing the lithium compound by an organic compound. The organic compound is formed by reacting a nucleophilic compound with a compound containing at least one ethylene unsaturated group. The nucleophilic compound includes a barbiturate compound, thiobarbituric acid, cyanuric acid, trithiocyanic acid, or a pyrimidine compound. The compound containing at least one ethylene unsaturated group includes an acrylic epoxy resin, a maleimide compound, or a pyrimidine compound. The lithium compound includes lithium carbonate, lithium hydroxide, or a combination thereof.

In some embodiments, the barbiturate compound has a structure represented by formula (1-1):

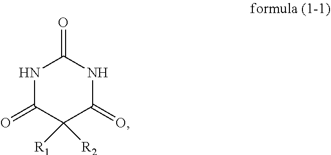

in which R₁ and R₂ are each independently —H, a linear C1-C10 alkylene group, or a branched C1-C10 alkylene group.

In some embodiments, the acrylic epoxy resin has a structure represented by formula (2-1):

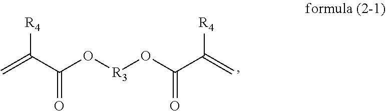

in which R₃ is a C1-C30 alkylene group or a C2-C30 ether group, and R₄ is —H, —CH₃, or —CF₃.

In some embodiments, the acrylic epoxy resin has a structure represented by formula (2-2):

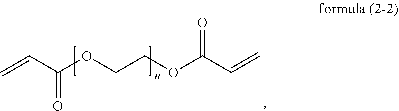

in which n is a positive integer of 1-15.

In some embodiments, the maleimide compound includes a monomaleimide compound or a bismaleimide compound.

In some embodiments, a molar ratio of the nucleophilic compound to the compound containing at least one ethylene unsaturated group is 1:1 to 1:2.

In some embodiments, before the lithium compound is decomposed by the organic compound, the nucleophilic compound and the compound containing at least one ethylene unsaturated group are reacted in a solvent to form an organic compound solution containing the organic compound, in which the solvent includes N-methylpyrrolidone, γ-butyrolactone, propylene carbonate, dimethyl sulfoxide, dimethylacetamide, or combinations thereof.

In some embodiments, a pH value of the organic compound solution is 4 to 6.

In some embodiments, a reaction temperature of decomposing the lithium compound by the organic compound is 60° C. to 150° C.

In some embodiments, a reaction time of decomposing the lithium compound by the organic compound is 3 hours to 15 hours.

In some embodiments, a reaction temperature of reacting the nucleophilic compound with the compound containing at least one ethylene unsaturated group is 50° C. to 200° C.

In some embodiments, a reaction time of reacting the nucleophilic compound with the compound containing at least one ethylene unsaturated group is 0.25 hours to 18 hours.

The present disclosure provides a method for decomposing a lithium compound, and the method includes reacting an organic compound having

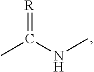

—OC—N═CO—, or —SC—N═CS— with the lithium compound to decompose the lithium compound, in which R is O or S, the lithium compound includes lithium carbonate, lithium hydroxide, or a combination thereof, and a reaction temperature is 60° C. to 150° C.

In some embodiments, a reaction time of reacting the organic compound having

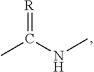

—OC—N═CO—, or —SC—N═CS— with the lithium compound is 3 hours to 15 hours.

In some embodiments, the organic compound having

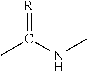

includes

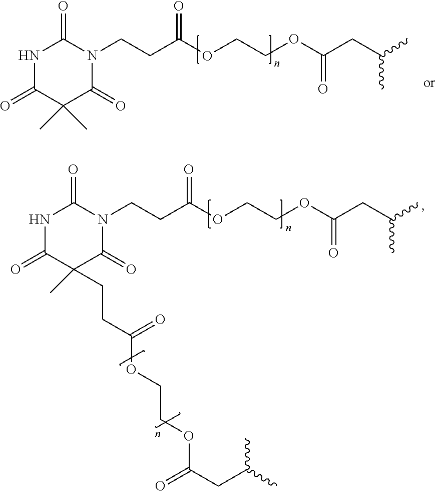

n is a positive integer of 1-15, and a “ [symbol] ” symbol represents that a position is bonded to hydrogen or a chemical structure generated by

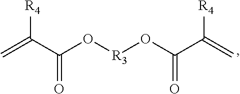

and R₃ is a C1-C30 alkylene group or a C2-C30 ether group, and R₄ is —H, —CH₃, or —CF₃.

In some embodiments, the organic compound having —OC—N═CO— includes

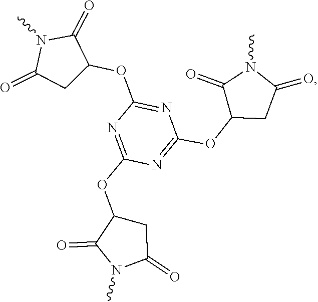

a “ [symbol] ” symbol represents that a position is bonded to hydrogen or a chemical structure generated by

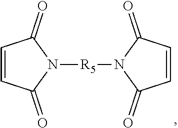

and R₅ is a linear C1-C12 alkylene group or C6-C13 aryl group, or a branched C1-C12 alkylene group or C6-C13 aryl group.

In some embodiments, the organic compound having —SC—N═CS— includes

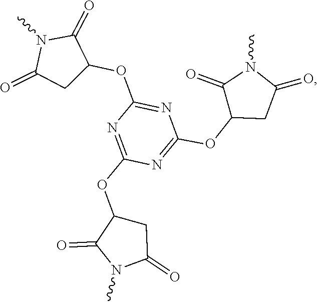

a “ [symbol] ” symbol represents that a position is bonded to hydrogen or a chemical structure generated by

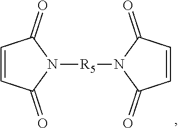

and R₅ is a linear C1-C12 alkylene group or C6-C13 aryl group, or a branched C1-C12 alkylene group or C6-C13 aryl group.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings.

FIG. 1A is a hydrogen nuclear magnetic resonance spectrum of an organic compound of example 1-1.

FIG. 1B is a hydrogen nuclear magnetic resonance spectrum of an organic compound of example 3-1 after decomposing lithium hydroxide.

FIG. 1C is a hydrogen nuclear magnetic resonance spectrum of the organic compound of example 3-2 after decomposing lithium carbonate.

FIG. 1D is a hydrogen nuclear magnetic resonance spectrum of an organic compound of example 2-1 after decomposing lithium carbonate and lithium hydroxide on the surface of damaged nickel oxide.

FIG. 1E is a hydrogen nuclear magnetic resonance spectrum of the organic compound of example 2-2 after decomposing lithium carbonate and lithium hydroxide on the surface of damaged lithium nickel oxide.

FIG. 2A is a charge-discharge curve diagram of lithium nickel oxide of comparative example 1-1, damaged lithium nickel oxide of comparative example 1-2, and the organic compound of the example 2-2 after decomposing lithium carbonate and lithium hydroxide on the surface of damaged lithium nickel oxide.

FIG. 2B is a charge-discharge curve diagram of damaged lithium nickel cobalt manganese oxide of comparative example 1-3 and an organic compound of example 2-3 after decomposing lithium carbonate and lithium hydroxide on the surface of damaged lithium nickel cobalt manganese oxide.

### DETAILED DESCRIPTION

In order to make the description of the present disclosure more detailed and complete, the following provides an illustrative description of the embodiments and specific embodiments of the present disclosure; but this is not the only way to implement or use the specific embodiments of the present disclosure. The various embodiments disclosed below can be combined or replaced with each other under beneficial circumstances, and other embodiments can also be added to some embodiments without further description or explanation.

In this article, the range represented by “one numerical value to another numerical value” is a summary expression that avoids enumerating all the numerical values in the range one by one in the specification. Therefore, the description of a specific numerical range covers any numerical value within the numerical range and the smaller numerical range defined by any numerical value within the numerical range. As if the arbitrary numerical value and the smaller numerical range expressly written in the description are the same.

The present disclosure provides a method for decomposing a lithium compound, and the method includes decomposing the lithium compound by an organic compound. The organic compound is formed by reacting a nucleophilic compound with a compound containing at least one ethylene unsaturated group. The nucleophilic compound includes a barbiturate compound, thiobarbituric acid, cyanuric acid, trithiocyanic acid, or a pyrimidine compound. The compound containing at least one ethylene unsaturated group includes an acrylic epoxy resin, a maleimide compound, or a pyrimidine compound. The lithium compound includes lithium carbonate, lithium hydroxide, or a combination thereof. The method for decomposing the lithium compound has a lower reaction temperature (for example, 60° C. to 150° C.) and a shorter reaction time (for example, 3 hours to 15 hours), and thus it is able to decompose the lithium compound under milder conditions and improve decomposition efficiency.

In some embodiments, the barbiturate compound has a structure represented by formula (1-1):

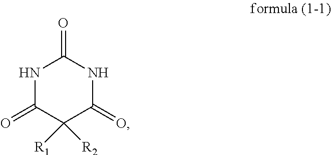

in which R₁ and R₂ are each independently —H, a linear or a branched C1-C10 alkylene group. R₁ and R₂ can have a carbon number of 1, 2, 3, 4, 5, 6, 7, 8, 9, or 10. For example, R₁ and R₂ are each independently —H, —CH₃, —C₆H₅, —CH(CH₃)₂, —CH₂CH(CH₃)₂, —CH₂CH₂CH(CH₃)₂, or

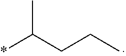 [SMILES: *C(C)CCC]

The structures of R₁ and R₂ may be the same of different.

In some embodiments, the pyrimidine compound includes uracil, thymine, or cytosine.

In some embodiments, the acrylic epoxy resin has a structure represented by formula (2-1):

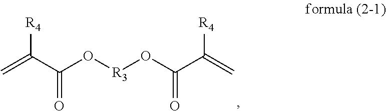

in which R₃ is a C1-C30 alkylene group or a C2-C30 ether group. The C1-C30 alkylene group can have a carbon number of 1, 2, 4, 6, 8, 10, 12, 14, 16, 18, 20, 22, 24, 26, 28, or 30. The C2-C30 ether group can have a carbon number of 2, 4, 6, 8, 10, 12, 14, 16, 18, 20, 22, 24, 26, 28, or 30. For example, R₃ is —(CH₂)—, (CH₂)₅—, —(CH₂)₁₀—, —(CH₂)₁₅—, —(CH₂)₂₀—, —(CH₂)₂₅—, —(CH₂)₃₀—, —CH₂—O—CH₂—, (CH₂)₃—O—(CH₂)₃—, —(CH₂)₆—O—(CH₂)₆—, —(CH₂)₉—O—(CH₂)₉—, —(CH₂)₁₂—O—(CH₂)₁₂—, or (CH₂)₁₅—O—(CH₂)₁₅—. R₄ is —H, —CH₃, or —CF₃.

In some embodiments, the acrylic epoxy resin has a structure represented by formula (2-2):

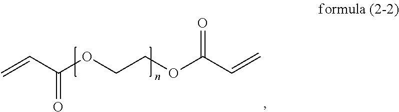

in which n is a positive integer of 1-15, such as 1, 2, 3, 4, 5, 6, 7, 8, 9, 10, 11, 12, 13, 14, or 15.

In some embodiments, the maleimide compound includes a monomaleimide compound or a bismaleimide compound.

In some embodiments, the monomaleimide compound includes N-phenylmaleimide, N-(ortho-methylphenyl)-maleimide, N-(meta-methylphenyl)-maleimide, N-(para-methylphenyl)-maleimide, N-cyclohexylmaleimide, maleimidophenol, maleimidobenzocyclobutene, phosphorus-containing maleimide, phosphoric maleimide, siloxy maleimide, N-(tetrahydropyranyl-oxyphenyl) maleimide, 2,6-xylylmaleimide, or combinations thereof.

In some embodiments, the bismaleimide compound has a structure represented by formula (2-3):

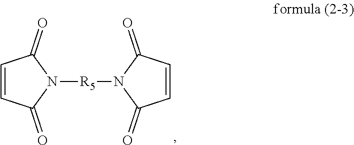

in which R₅ is a linear C1-C12 alkylene group or C6-C13 aryl group, or a branched C1-C12 alkylene group or C6-C13 aryl group. The C1-C12 alkylene group can have a carbon number of 1, 2, 3, 4, 5, 6, 7, 8, 9, 10, 11, or 12. The C6-C13 aryl group can have a carbon number of 6, 7, 8, 9, 10, 11, 12, or 13. For example, R₅ is —(CH₂)—, —(CH₂)₂—, —(CH₂)₄—, —(CH₂)₆—, —(CH₂)₈—, —(CH₂)₁₀—, —(CH₂)₁₂—,

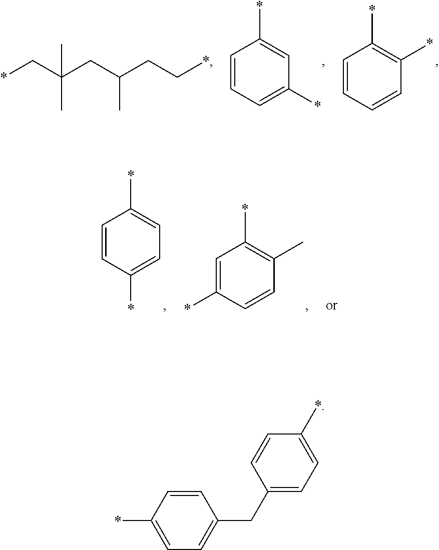

In the present disclosure, the organic compound is formed by reacting the nucleophilic compound with the compound containing at least one ethylene unsaturated group. In some embodiments, the nucleophilic compound and the compound containing at least one ethylene unsaturated group are dissolved in a solvent and heated in an environment, in which an inert gas is introduced, to prepare the organic compound.

In some embodiments, the inert gas includes helium gas, neon gas, argon gas, krypton gas, xenon gas, radon gas, or combinations thereof.

In some embodiments, the organic compound is formed by reacting the barbiturate compound with the acrylic epoxy resin. In some embodiments, the organic compound is formed by reacting cyanuric acid with the maleimide compound. In some embodiments, the organic compound is formed by reacting trithiocyanic acid with the bismaleimide compound. In some embodiments, the organic compound is formed by reacting thiobarbituric acid with the bismaleimide compound. In some embodiments, the organic compound is formed by reacting the same or different pyrimidine compounds.

The nucleophilic compound and the compound containing at least one ethylene unsaturated group will undergo a Michael addition reaction to generate the organic compound. Furthermore, in some embodiments, a secondary amine, secondary carbon atom(s), or a combination thereof in the nucleophilic compound may be bonded to carbon atom(s) of the ethylene unsaturated group in the compound containing at least one ethylene unsaturated group to generate the organic compound. In another embodiments, a tertiary alcohol in the nucleophilic compound may be bonded to carbon atom(s) of the ethylene unsaturated group in the compound containing at least one ethylene unsaturated group to generate the organic compound. In another embodiments, a tertiary thiol in the nucleophilic compound may be bonded to carbon atom(s) of the ethylene unsaturated group in the compound containing at least one ethylene unsaturated group to generate the organic compound.

In some embodiments, the organic compound prepared by the nucleophilic compound and the compound containing at least one ethylene unsaturated group has a structure represented by formula (3-1):

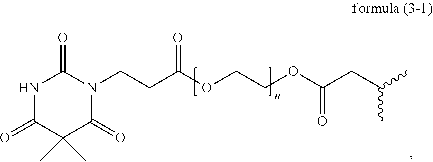

in which n is the positive integer of 1-15, such as 1, 2, 3, 4, 5, 6, 7, 8, 9, 10, 11, 12, 13, 14, or 15. The structure represented by the formula (3-1) has the effect of decomposing the lithium compound.

In some embodiments, the organic compound prepared by the nucleophilic compound and the compound containing at least one ethylene unsaturated group has a structure represented by formula (3-2):

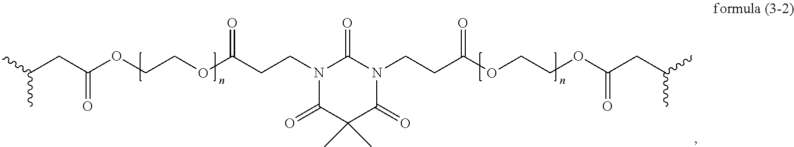

in which n is the positive integer of 1-15, such as 1, 2, 3, 4, 5, 6, 7, 8, 9, 10, 11, 12, 13, 14, or 15.

In some embodiments, the organic compound prepared by the nucleophilic compound and the compound containing at least one ethylene unsaturated group has a structure represented by formula (3-3):

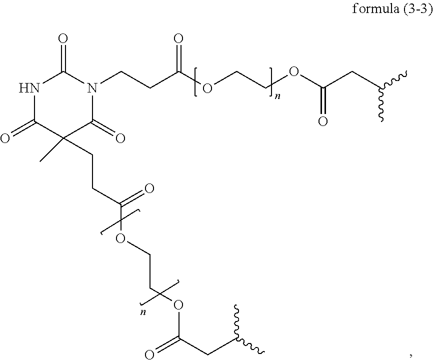

in which n is the positive integer of 1-15, such as 1, 2, 3, 4, 5, 6, 7, 8, 9, 10, 11, 12, 13, 14, or 15. The structure represented by the formula (3-3) has the effect of decomposing the lithium compound.

In some embodiments, the organic compound prepared by the nucleophilic compound and the compound containing at least one ethylene unsaturated group has a structure represented by formula (3-4):

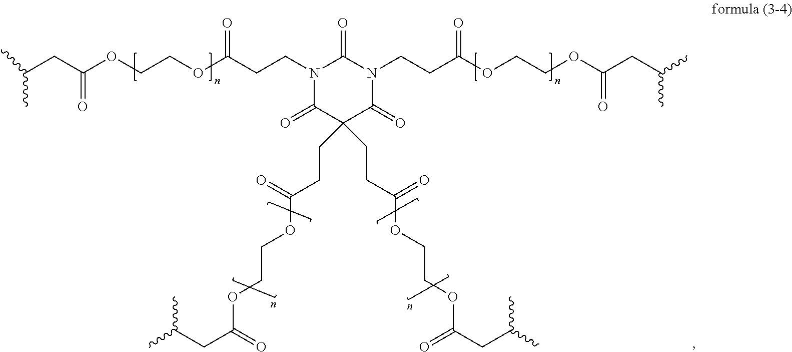

in which n is the positive integer of 1-15, such as 1, 2, 3, 4, 5, 6, 7, 8, 9, 10, 11, 12, 13, 14, or 15.

In some embodiments, the organic compound prepared by the nucleophilic compound and the compound containing at least one ethylene unsaturated group has a structure represented by formula (3-5):

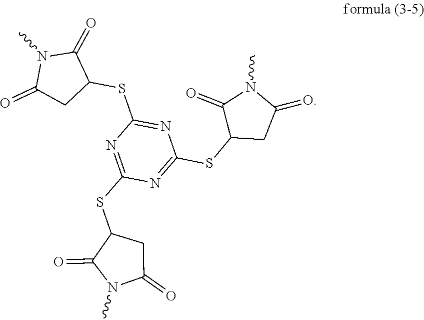

The structure represented by the formula (3-5) has the effect of decomposing the lithium compound.

In some embodiments, the organic compound prepared by the nucleophilic compound and the compound containing at least one ethylene unsaturated group has a structure represented by formula (3-6):

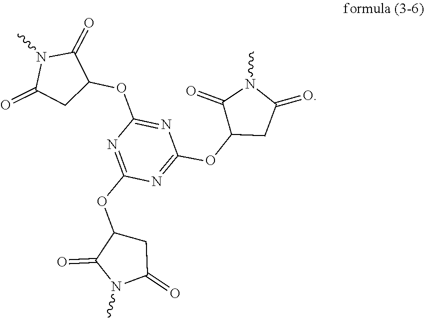

The structure represented by the formula (3-6) has the effect of decomposing the lithium compound.

In the above formula (3-1) to formula (3-4), the “ [symbol] ” symbol represents that the position can be bonded to, for example, hydrogen, or the chemical structure generated by the formula (2-1). In the above formula (3-5) to formula (3-6), the “ [symbol] ” symbol represents that the position can be bonded to, for example, hydrogen, or the chemical structure generated by the formula (2-3).

In some embodiments, the molar ratio of the nucleophilic compound to the compound containing at least one ethylene unsaturated group is 1:1 to 1:2, such as 1:1, 1:1.2, 1:1.4, 1:1.6, 1:1.8, or 1:2. If the molar ratio of the nucleophilic compound to the compound containing at least one ethylene unsaturated group is 1:1 to 1:2, the reactivity is better, and side reactions are less likely to occur.

In some embodiments, before the lithium compound is decomposed by the organic compound, the nucleophilic compound and the compound containing at least one ethylene unsaturated group are reacted in a solvent to form the organic compound solution containing the organic compound, in which the solvent includes N-methylpyrrolidone, γ-butyrolactone, propylene carbonate, dimethyl sulfoxide, dimethylacetamide, or combinations thereof.

In some embodiments, before the lithium compound is decomposed by the organic compound, a reaction mixture of the nucleophilic compound and the compound containing at least one ethylene unsaturated group is reacted in the solvent to form the organic compound solution containing the organic compound, in which a weight ratio of the reaction mixture to the solvent is 5:95 to 8:92, such as 5:95, 6:94, 7:93, or 8:92. If the weight ratio of the reaction mixture to the solvent is 5:95 to 8:92, the reaction rate is fast, and the prepared organic compound can be stored stably.

In some embodiments, before the lithium compound is decomposed by the organic compound, the nucleophilic compound and the compound containing at least one ethylene unsaturated group are dissolved in the solvent, in which a dissolving time is 10 minutes to 30 minutes, such as 10, 20, or 30 minutes.

In some embodiments, before the lithium compound is decomposed by the organic compound, the nucleophilic compound is reacted with the compound containing at least one ethylene unsaturated group, in which a reaction temperature is 50° C. to 200° C., such as 50, 75, 90, 115, 130, 145, 170, 185, or 200° C.

In some embodiments, before the lithium compound is decomposed by the organic compound, the nucleophilic compound is reacted with the compound containing at least one ethylene unsaturated group, in which a reaction time is 0.25 hours to 18 hours, such as 0.25, 0.5, 1, 4, 7, 10, 13, 16, or 18 hour(s).

In some embodiments, a pH value of the organic compound solution is 4 to 6, such as 4, 4.5, 5, 5.5, or 6.

In some embodiments, the lithium compound is derived from a surface of a damaged nickel-rich material, in which the surface of the damaged nickel-rich material refers to the nickel-rich material stored in a humid environment for a long time, thereby generating the lithium compound on the surface of the nickel-rich material, or the nickel-rich material is used as a cathode material of a lithium battery, thereby generating the lithium compound on the surface of the nickel-rich material. For example, the nickel-rich material can be used as the cathode material of the lithium battery.

In some embodiments, the method for decomposing the lithium compound is to decompose the lithium compound by the organic compound. In detail, the organic compound reacts with the damaged nickel-rich material in a sufficient amount of the solvent to decompose the lithium compound, in which the sufficient amount of the solvent is the amount of the solvent that just covers the organic compound and the damaged nickel-rich material.

In some embodiments, the nickel-rich material includes lithium nickel oxide, nickel oxide, lithium nickel cobalt manganese oxide, or lithium nickel cobalt aluminum oxide.

In some embodiments, in the decomposition of the lithium compound by the organic compound, a weight ratio of the organic compound to the lithium compound on the surface of the damaged nickel-rich material is 0.05:99.95 to 2:98. For example, the weight ratio of the organic compound to the lithium compound on the surface of the damaged nickel-rich material is 0.05:99.95, 0.1:99.9, 0.5:99.5, 1:99, 1.5:98.5, or 2:98.

In some embodiments, a solvent used to decompose the lithium compound by the organic compound includes N-methylpyrrolidone, γ-butyrolactone, propylene carbonate, dimethyl sulfoxide, dimethylacetamide, or combinations thereof.

In some embodiments, a reaction temperature of decomposing the lithium compound by the organic compound is 60° C. to 150° C., such as 60, 70, 80, 90, 100, 110, 120, 130, 140, or 150° C. If the organic compound is not added, the lithium compound needs to be decomposed at a high temperature, such as 700° C. to 900° C. The organic compound of the present disclosure can decompose the lithium compound at a lower temperature, in which the lower temperature is relative to the decomposition temperature required when no organic compound is added.

In some embodiments, a reaction time of decomposing the lithium compound by the organic compound is 3 hours to 15 hours, such as 3, 5, 7, 9, 11, 13, or 15 hours. If the organic compound is not added, using a method like electrochemistry requires high voltage oxidation to decompose the lithium compound. The organic compound of the present disclosure can decompose the lithium compound in a shorter time and without voltage, in which the shorter time is relative to the decomposition time required when no organic compound is added.

In some embodiments, the organic compound with structure(s) such as

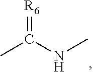

—OC—N═CO—, or —SC—N═CS— can be used to decompose the lithium compound, in which R₆ is O or S. Since a carbonyl group or a carbon-sulfur double bond in the structure

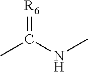

has electron-withdrawing properties, the electron-withdrawing properties of which can be utilized to displace the lithium ions in the lithium compound and desorb hydrogen on nitrogen at the same time. The structure —OC—N═CO— or —SC—N═CS— can directly absorb the lithium ion(s) and combine with it to form a lithium amide compound because of the lone pair on the nitrogen atom.

The features of the present disclosure will be described in more detail below with reference to experimental examples 1 to 4. Although the following experimental examples are described, the materials, the amounts and ratios thereof, the processing details, and the processing procedures, and the like which is used may be appropriately changed without exceeding from the scope of the present disclosure. Therefore, the present disclosure should not be interpreted restrictively by the experimental examples described below.

### Experimental Example 1: Preparation of the Organic Compound

In example 1-1, barbituric acid (having the structure represented by the formula (1-1) and R₁ and R₂ are —CH₃) and the acrylic epoxy resin (having the structure represented by the formula (2-2), n is 6) at a molar ratio of 1:2 were mixed and dissolved in N-methylpyrrolidone; and the reactants were reacted at 115° C. for 30 minutes in an argon environment to form an organic compound (having the structure represented by the formula (3-1) and/or the structure represented by the formula (3-2)).

In example 1-2, trithiocyanic acid and bismaleimide at a molar ratio of 2:3 were mixed and dissolved in N-methylpyrrolidone; and the reactants were reacted at 130° C. for 8 hours in the argon environment to form an organic compound.

In example 1-3, thiobarbituric acid and bismaleimide at a molar ratio of 1:2 are mixed and dissolved in N-methylpyrrolidone; and the reactants are reacted at 100° C. for 18 hours in the argon environment to form an organic compound.

In example 1-4, 0.8 parts by weight of uracil was dissolved in 99.2 parts by weight of N-methylpyrrolidone and reacted at 130° C. for 18 hours in the argon environment to form an organic compound.

In example 1-5, cyanuric acid was mixed with the sufficient amount of dimethyl sulfoxide to form a cyanuric acid solution, and then the cyanuric acid solution and the maleimide compound at a molar ratio of 1:2 were reacted at 130° C. for 1 hour in the argon environment to form an organic compound.

### Experimental Example 2: Method for Decomposing the Lithium Compound

In example 2-1, 0.5 parts by weight of the organic compound of the example 1-1 was mixed with 99.5 parts by weight of the damaged nickel oxide material; and the reactants in a sufficient amount of N-methylpyrrolidone were reacted at 120° C. for 12 hours to decompose lithium carbonate and lithium hydroxide on the surface of the damaged nickel oxide material.

In example 2-2, 0.5 parts by weight of the organic compound of the example 1-1 was mixed with 99.5 parts by weight of the damaged lithium nickel oxide material; and the reactants in a sufficient amount of N-methylpyrrolidone were reacted at 120° C. for 12 hours to decompose lithium carbonate and lithium hydroxide on the surface of the damaged lithium nickel oxide material.

In example 2-3, 0.05 parts by weight of the organic compound of the example 1-1 was mixed with 99.95 parts by weight of the damaged lithium nickel cobalt manganese oxide material; and the reactants in a sufficient amount of N-methylpyrrolidone were reacted at 120° C. for 12 hours to decompose lithium carbonate and lithium hydroxide on the surface of the damaged lithium nickel cobalt manganese oxide material.

### Experimental Example 3: The Decomposition of the Lithium Compound

In example 3-1, the organic compound of the example 1-1 was mixed and reacted with lithium hydroxide at a weight ratio of 1:2 for measuring the hydrogen nuclear magnetic resonance spectrum.

In example 3-2, the organic compound of the example 1-1 was mixed and reacted with lithium carbonate at a weight ratio of 1:2 for measuring the hydrogen nuclear magnetic resonance spectrum.

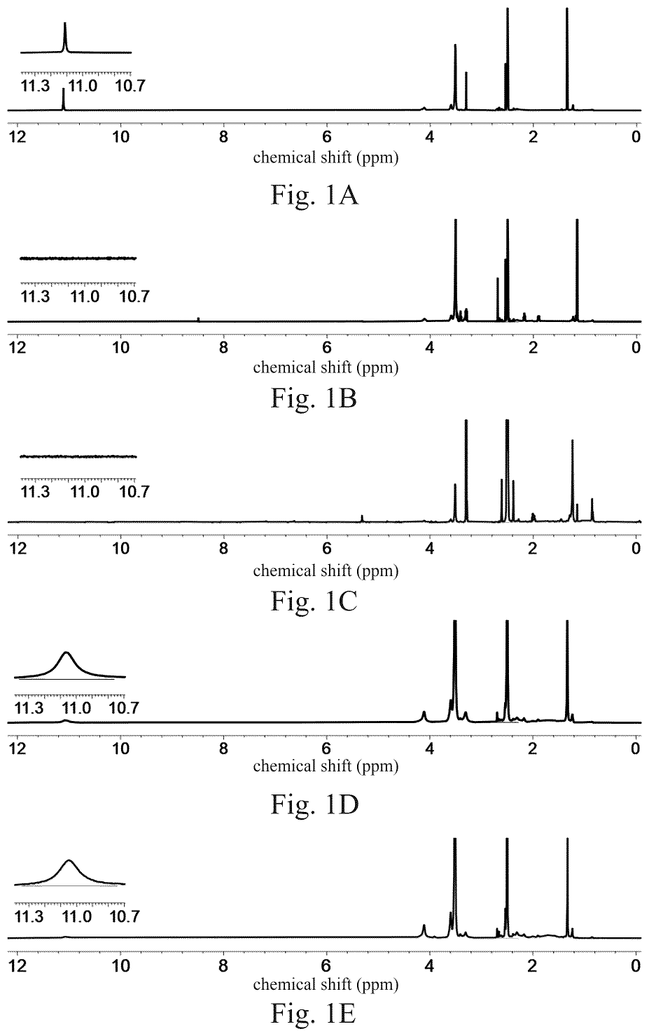

FIGS. 1A-1E are the hydrogen nuclear magnetic resonance spectrum of the organic compound of the example 1-1, the hydrogen nuclear magnetic resonance spectrum of the organic compound of the example 3-1 after decomposing lithium hydroxide, the hydrogen nuclear magnetic resonance spectrum of the organic compound of the example 3-2 after decomposing lithium carbonate, the hydrogen nuclear magnetic resonance spectrum of the organic compound of example 2-1 after decomposing lithium carbonate and lithium hydroxide on the surface of damaged nickel oxide, and the hydrogen nuclear magnetic resonance spectrum of the organic compound of example 2-2 after decomposing lithium carbonate and lithium hydroxide on the surface of damaged lithium nickel oxide in sequence. The experimental conditions were as follows: deuterated dimethyl sulfoxide was used as the deuterated solvent, and the field strength was set at 500 mHz. The upper-left diagrams of FIGS. 1A-1E are partial enlarged views of 10.7 ppm to 11.4 ppm. It can be found in the examples 1-1, 2-1, and 2-2 that peaks with integrated areas of 0.17, 0.11, and 0.07 are located between 10.7 ppm and 11.4 ppm, which is hydrogen on nitrogen in the organic compound (having the structure represented by the formula (3-1) and the formula (3-2)). Comparing the examples 1-1, 3-1, and 3-2 with each other, it can be found that the peaks located between 10.7 ppm and 11.4 ppm in the examples 3-1 and 3-2 are disappeared. That is, when the lithium compounds are added to the organic compound, the organic compound can decompose the lithium compound and cause hydrogen on nitrogen in the organic compound to disappear. When the examples 1-1, 2-1, and 2-2 are further compared with each other, it will be found that comparing to the integrated area of hydrogen on nitrogen in the example 1-1, the integrated area of hydrogen on nitrogen in the examples 2-1 and 2-2 are smaller. That is, when the damaged nickel-rich material is added in the organic compound, due to the surface of the damaged nickel-rich material having the lithium compound, the addition of the organic compound can decompose the lithium compound on the surface of the nickel-rich material.

### Experimental Example 4: Battery Charge and Discharge Experiment

In the comparative example 1-1 of the present disclosure, lithium nickel oxide is used as the cathode of the battery to conduct the battery charge and discharge experiment.

In the comparative example 1-2 of the present disclosure, the damaged lithium nickel oxide is used as the cathode of the battery to conduct the battery charge and discharge experiment.

In the comparative example 1-3 of the present disclosure, the damaged lithium nickel cobalt manganese oxide is used as the cathode of the battery to conduct the battery charge and discharge experiment.

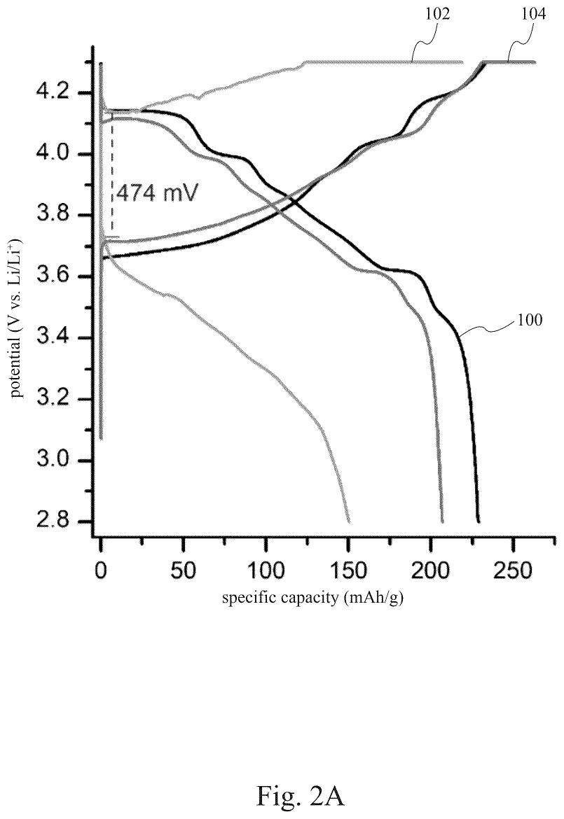

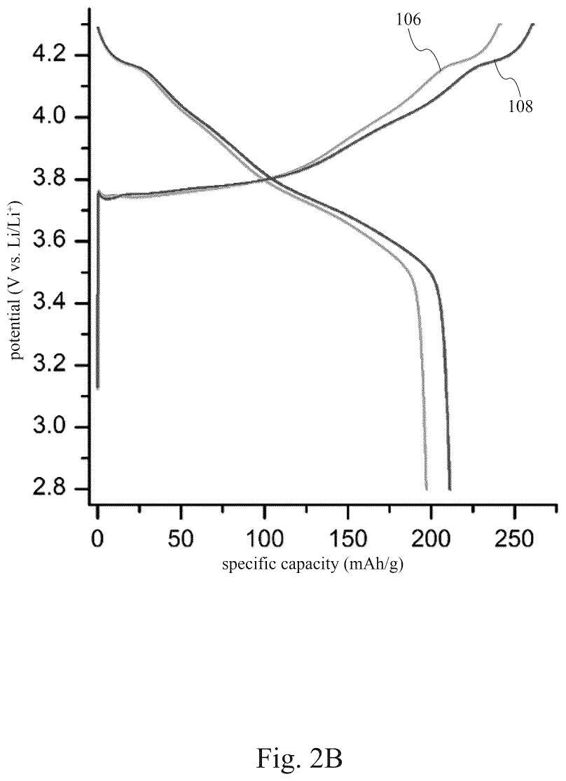

In FIG. 2A, the curve 100 is the charge-discharge curve diagram of lithium nickel oxide of the comparative example 1-1; the curve 102 is the charge-discharge curve of the damaged lithium nickel oxide of comparative example 1-2; the curve 104 is the charge-discharge curve of the organic compound of the example 2-2 after decomposing lithium carbonate and lithium hydroxide on the surface of the damaged lithium nickel oxide. In FIG. 2B, the curve 106 is the charge-discharge curve of the damaged lithium nickel cobalt manganese oxide of the comparative example 1-3; and the curve 108 is the charge-discharge curve of the organic compound of the example 2-3 after decomposing lithium carbonate and lithium hydroxide on the surface of the damaged lithium nickel cobalt manganese oxide. The same testing conditions were used in FIGS. 2A and 2B. That is, in the first cycle of battery charging and discharging, the battery is discharged to 2.8 V vs. Li/Li⁺ (the unit in the specification is V, which represents V vs. Li/Li⁺) and is charged to 4.3 V, the current is 0.1 C, and the temperature is 30° C., in which C is the magnitude of the battery charging and discharging current. 1C is defined as the magnitude of the current required to discharge the battery capacity for 1 hour, and 0.1C represents the current required to discharge the battery capacity completely for 10 hours. For example, for a battery with a capacity of 100 mAh, the current of 1 C is 100 mA and the current of 0.1C is 10 mA. It can be found in FIGS. 2A and 2B that the specific capacity of the curve 100 of the comparative example 1-1 and the curve 104 of the example 2-2 is better than the specific capacity of the curve 102 of the comparative example 1-2, and the specific capacity of the curve 108 of the example 2-3 is better than the specific capacity of the curve 106 of the comparative example 1-3. In detail, when the nickel-rich material is damaged, the specific capacity of the battery is significantly less than the specific capacity of the nickel-rich material. It is because the presence of the lithium compound on the surface of the damaged nickel-rich material reduces the specific capacity. When the organic compound is added in the damaged nickel-rich material, the specific capacity of which may be close to the specific capacity of the nickel-rich material because the organic compound can decompose the lithium compound on the surface of the damaged nickel-rich material. In addition, in FIG. 2A, the curve 102 of the comparative example 1-2 (474 mV) has a larger polarization phenomenon than the curve 104 of the example 1-2. That is, the polarization phenomenon of the damaged nickel-rich material is greater than the polarization phenomenon of the damaged nickel-rich material after adding the organic compound, which represents that the damaged nickel-rich material has a poor battery performance.

The above method of decomposing the lithium compound is decomposed by reacting the organic compound with the lithium compound on the surface of the damaged nickel-rich material, in which the decomposition method is to replace the lithium ions in the lithium compound through acidification and the structural transformation of the organic compound. The organic compound can be represented by the formula (3-1):

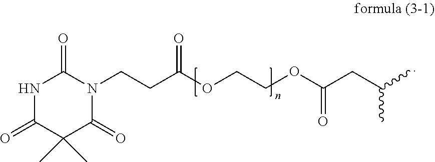

When the organic compound is added to the damaged nickel-rich material for reaction, hydrogen on nitrogen of the organic compound breaks bond and the nitrogen bonds with the nickel ion on the damaged nickel-rich material simultaneously. Then, the lithium compound interacts with the carbonyl group adjacent to the nickel ion bonded nitrogen on the organic compound through electron transfer. Further, the carbonyl group can replace the lithium ion(s) in the lithium compound by its' electron-withdrawing properties, thereby promoting the decomposition of the lithium compound. The organic structure after the final reaction can be represented by formula (3-7).

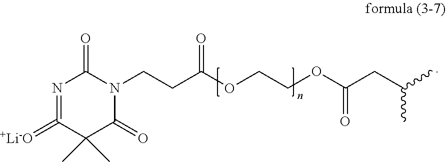

Besides, the pH value of the organic compound solution is 5.5. Therefore, the lithium compound on the surface of the damaged nickel-rich material decomposes in the organic compound solution with acid environment.

In summary, the present disclosure provides the method for decomposing the lithium compound(s), including the decomposition of the lithium compound by the organic compound. The organic compound is formed by reacting the nucleophilic compound with the compound containing at least one ethylene unsaturated group. Compared with the conditions without adding the organic compound, the organic compound of the present disclosure can decompose the lithium compound(s) at a lower temperature and a shorter time. The organic compound of the present disclosure with the structure of

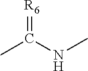

(R₆ is O or S), —OC—N═CO—, or —SC—N═CS— has the effect of decomposing the lithium compound.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for decomposing a lithium compound, comprising:
decomposing the lithium compound by an organic compound, wherein the organic compound is formed by reacting a nucleophilic compound with a compound containing at least one ethylene unsaturated group, the nucleophilic compound comprises a barbiturate compound, thiobarbituric acid, cyanuric acid, trithiocyanic acid, or a pyrimidine compound, the compound containing at least one ethylene unsaturated group comprises an acrylic epoxy resin, a maleimide compound, or a pyrimidine compound, and the lithium compound comprises lithium carbonate, lithium hydroxide, or a combination thereof.

2. The method of claim 1, wherein the barbiturate compound has a structure represented by formula (1-1): 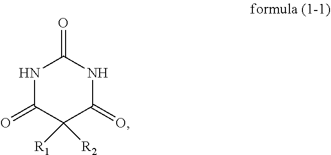
wherein R₁ and R₂ are each independently —H, a linear C1-C10 alkylene group, or a branched C1-C10 alkylene group.

3. The method of claim 1, wherein the acrylic epoxy resin has a structure represented by formula (2-1): 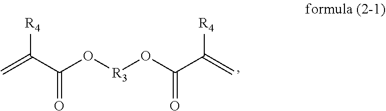
wherein R₃ is a C1-C30 alkylene group or a C2-C30 ether group, and R₄ is —H, —CH₃, or —CF₃.

4. The method of claim 3, wherein the acrylic epoxy resin has a structure represented by formula (2-2): 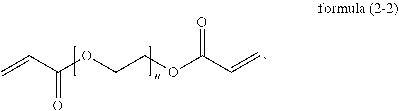
wherein n is a positive integer of 1-15.

5. The method of claim 1, wherein the maleimide compound comprises a monomaleimide compound or a bismaleimide compound.

6. The method of claim 1, wherein a molar ratio of the nucleophilic compound to the compound containing at least one ethylene unsaturated group is 1:1 to 1:2.

7. The method of claim 1, further comprising:
before decomposing the lithium compound by the organic compound, reacting the nucleophilic compound with the compound containing at least one ethylene unsaturated group in a solvent to form an organic compound solution containing the organic compound, wherein the solvent comprises N-methylpyrrolidone, γ-butyrolactone, propylene carbonate, dimethyl sulfoxide, dimethylacetamide, or combinations thereof.

8. The method of claim 7, wherein a pH value of the organic compound solution is 4 to 6.

9. The method of claim 1, wherein a reaction temperature of decomposing the lithium compound by the organic compound is 60° C. to 150° C.

10. The method of claim 1, wherein a reaction time of decomposing the lithium compound by the organic compound is 3 hours to 15 hours.

11. The method of claim 1, wherein a reaction temperature of reacting the nucleophilic compound with the compound containing at least one ethylene unsaturated group is 50° C. to 200° C.

12. The method of claim 1, wherein a reaction time of reacting the nucleophilic compound with the compound containing at least one ethylene unsaturated group is 0.25 hours to 18 hours.

13. A method for decomposing a lithium compound, comprising:
reacting an organic compound having 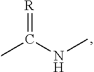
—OC—N═CO—, or —SC—N═CS— with the lithium compound to decompose the lithium compound, wherein R is O or S, the lithium compound comprises lithium carbonate, lithium hydroxide, or a combination thereof, and a reaction temperature is 60° C. to 150° C.

14. The method of claim 13, wherein a reaction time of reacting the organic compound having 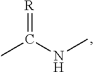
—OC—N═CO—, or —SC—N═CS— with the lithium compound is 3 hours to 15 hours.

15. The method of claim 13, wherein the organic compound having 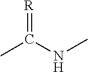
comprises 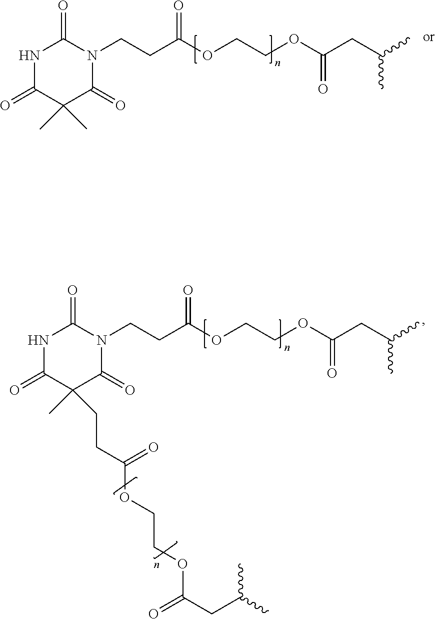
n is a positive integer of 1-15, and a “ [symbol] ” symbol represents that a position is bonded to hydrogen or a chemical structure generated by 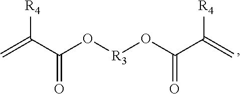
and R₃ is a C1-C30 alkylene group or a C2-C30 ether group, and R₄ is —H, —CH₃, or —CF₃.

16. The method of claim 13, wherein the organic compound having —OC—N═CO— comprises 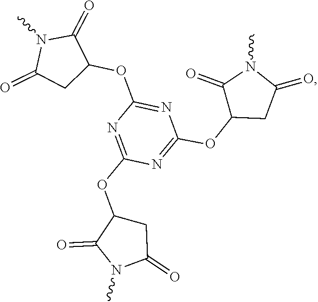
a “ [symbol] ” symbol represents that a position is bonded to hydrogen or a chemical structure generated by 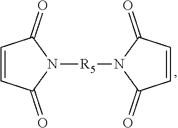
and R₅ is a linear C1-C12 alkylene group or C6-C13 aryl group, or a branched C1-C12 alkylene group or C6-C13 aryl group.

17. The method of claim 13, wherein the organic compound having —SC—N═CS— comprises 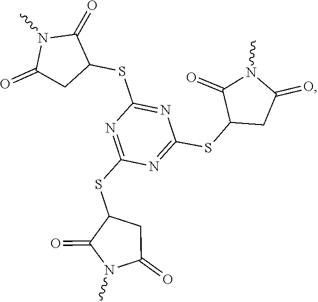
a “ [symbol] ” symbol represents that a position is bonded to hydrogen or a chemical structure generated by 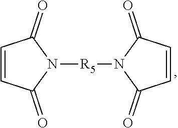
and R₅ is a linear C1-C12 alkylene group or C6-C13 aryl group, or a branched C1-C12 alkylene group or C6-C13 aryl group.
